(19) United States
(12) Patent Application Publication
(10) Pub. No.: US 2011/0309057 A1
(43) Pub. Date: Dec. 22, 2011

(54) LASER HEATING APPARATUS FOR METAL EUTECTIC BONDING

(75) Inventor: Hung Yi LIN, Taoyuan (TW)

(73) Assignee: TOUCH MICRO-SYSTEM TECHNOLOGY CORP., Taoyuan (TW)

(21) Appl. No.: 12/819,322

(22) Filed: Jun. 21, 2010

(51) Int. Cl. B23K 26/00

(52) U.S. Cl. 219/121.63

(57) ABSTRACT

A laser heating apparatus for metal eutectic bonding is disclosed in the present invention. The laser heating apparatus has a table for supporting a substrate having a first metal; a holding unit, located above the table and moving with respect to the table, for holding an object having a second metal above the table; and a laser generator, installed below the table and moving with respect to the table, for providing a laser beam which passes through the table and the substrate to melt the first metal, to facilitate the first metal to adhered to the second metal, thereby bonding the substrate with the object. The apparatus provides good heat conduction and stability. Furthermore, the holding unit used is not only for positioning, but also exerting a pressure on the bonding metals. It makes eutectic bonding process easier and more efficient.

### FIELD OF THE INVENTION

The present invention relates to a laser heating apparatus. More particularly, the present invention relates to a laser heating apparatus used for eutectic bonding of one or more metals or alloys to increase electrical conductivity, thermal conductivity and bonding quality of two objects.

### BACKGROUND OF THE INVENTION

Metal eutectic bonding method is widely used for bonding objects, especially for chip bonding. It can be used in packaging of micro-electro-mechanical system (MEMS), light emitting diode, laser diode, semiconductor, and 3D integration. A unique feature of the eutectic metal is that it can be melt like solder so as to make the bonding surface more even. Thus, even though there are protruding portions or particles on the surface, bonding still works.

Although the concept of eutectic bonding is easy to understand, how to apply it to a bonding apparatus for mass production is a knowhow. Please refer to FIGS. 1 to 3. U.S. Pat. No. 4,984,731 discloses a method to accomplish this goal.

FIG. 1 shows a plan view of a die bonding apparatus and FIG. 2 shows a side view of a substrate transportation path. Indicated by 1 is a conveyer for transporting a substrate 2, and disposed along the transportation path are a pre-heating unit 3, main heating unit 4 and a post heating unit 5. The substrate 2 is pre-heated by the pre-heating unit 3, and subsequently it is heated by the main heating unit 4 to a temperature above the eutectic temperature. Disposed along the line orthogonal to the main unit 4 are a part feeder 6 equipped with wafers 9, a die ejector 7 and an alignment unit 8. Indicated by 10 is a moving head which shuttles between the die ejector 7 and alignment unit 8, and picks up an electronic component part pushed up over the wafer 9 by the plunger of the die ejector 7 and feeds it to the alignment unit 8, by which the displacement of the part in the x, y and the direction is observed and corrected. Indicated by 11 is a mount head, which picks up the part on the alignment unit 8 and mounts it on the substrate 2 that has been heated by the main heating unit 4. Electronic component parts are packaged on the substrate 2 as shown by P.

In FIG. 2, the pre-heating unit 3 comprises a heater 15 and a cover 16 disposed over it, and serves to heat the substrate 2 to 150° C.-200° C. The main heating unit 4 also comprises a heater 17 and a cover 18 disposed over it, and serves to heat the substrate 2 to a temperature above the eutectic temperature. The eutectic temperature differs depending on the bonding material, and it is about 370° C. for eutectoid of gold and silicon, for example.

Indicated by 20 is a positioning unit for the substrate 2, and it comprises movable tables 21 and 22 moving in the X and Y directions, respectively, beneath the heater 17 which incorporates a heating element 17a. The mount head 11 moves into the interior of the cover 18 through an opening 23 formed in it and operates to bond an electronic component part P on the substrate 2 which has been positioned over the heater 17.

FIG. 3 shows the bonding process in which a part P held by a suction nozzle 12 is brought in contact with the substrate 2 and bonded to it. The nozzle 12 has a box-shaped suction tip 12a formed at its end. Indicated by 13 and 14 are bonding materials of gold, for example, provided on the bottom surface of the part P and the upper surface of the substrate 2. At a temperature above the eutectic temperature, the moving tables 21 and 22 are moved slightly so that the materials 13 and 14 are rendered a frictional slide, and the materials are connected. Consequently, the part P is bonded to the substrate 2.

Indicated by 24 is a camera located above the cover 18, and it is used to observe the thermal expansion of the substrate 2. A blower 25 is provided, and a blast of air removes a flame so as to ensure the clear observation of the substrate 2 for the camera 24. In order for the bonding materials 13 and 14 to be rid of oxidation during the heating of the substrate 2 by the main heating unit 4, such reducing gas as nitrogen or hydrogen is introduced to the interior of the cover 18 through a pipe 19. The pipe 19 supplies the reducing gas to the heater 17, and the gas heated by the heating element 17a is released through the upper surface of the heater 17 and it heats the substrate 2 (refer to the dashed arrows (λ)). The post heater 5, which comprises a heater 26 and a cover 27, heats the substrate 2 on which electronic component parts P have been bonded, and the substrate 2 is conveyed to the next processing apparatus. Bonding processes complete.

'731 patent is a very simple and useful invention for eutectic boding process, especially with monitoring thermal expansion of the substrate 2. However, with the development of technology, for state-of-the-art bonding apparatus, the heater 17 can be replaced with a laser emitting unit to heat the bonding materials 13 and 14. A universal mechanical arm is more convenient than the suction nozzle 12 which is used for picking up bonding material 13. No nitrogen or hydrogen is needed to prevent the bonding materials 13 and 14 from oxidation since laser emitting unit can provide more precise positioning for heating. Above all, thermal expansion of the substrate 2 can be ignored because the laser emitting unit can heat the bonding materials 13 and 14 but not the substrate 2.

Even the state-of-the-art bonding apparatus improves many shortcomings in the '731 patent, the eutectic bonding apparatus still faces many problems in mass production. The main problem is its size. The size compared with bonded object is so large that positioning needs more time. Furthermore, due to the complex design and large size of the mechanical arm, alignment is complicated. Therefore, mass production efficiency can not be increased. Meanwhile, providing heat from above of an object not only is hard to control the temperature passing on the object for heating the bonding materials, but also may cause damage to the object, thereby affecting the quality of the bonded object. Hence, in the present invention, a laser emitting unit is installed beneath a conveyer (table) to heat the bonding materials, thereby preventing the object from being damaged and temperature can be well controlled. Electrical and thermal conductivity can be improved. Furthermore, a mechanical arm is used not only for positioning, but also for exerting a pressure on bonding materials, thereby increasing the bonding intensity. The present invention makes eutectic bonding process easier and more efficient.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In accordance with an aspect of the present invention, a laser heating apparatus for metal eutectic bonding, comprises: a table, for supporting a substrate having a first metal; a holding unit, located above the table and moving with respect to the table, for holding an object having a second metal above the table; and a laser generator, installed below the table and moving with respect to the table, for providing a laser beam which passes through the table and the substrate to melt the first metal, to facilitate the first metal to adhered to the second metal, thereby bonding the substrate with the object.

Preferably, the holding unit heats the second metal before or when the second metal contacts the first metal.

Preferably, the holding unit does not heat the second metal either before or when the second metal contacts the first metal.

Preferably, the holding unit exerts a pressure onto the second metal when the second metal contacts the first metal.

Preferably, the holding unit does not exert a pressure onto the second metal when the second metal contacts the first metal.

Preferably, the substrate comprises a recess for accommodating the first metal.

Preferably, the holding unit is a mechanical arm.

Preferably, the holding unit is movable in two dimensions or three dimensions.

Preferably, the holding unit positions the second metal to contact the first metal.

Preferably, the first metal is a single element or is an alloy.

Preferably, the second metal is a single element or is an alloy.

Preferably, the table and the substrate are made of materials which are transparent to the laser beam.

Preferably, the table is made of silicon, plastic, glass, ceramic, zinc selenide (ZnSe), calcium fluoride (CaF2) or any other materials through which the laser beam can penetrate.

Preferably, the substrate is made of silicon, plastic, glass, ceramic, zinc selenide (ZnSe), calcium fluoride (CaF2) or any other materials through which the laser beam can penetrate.

Preferably, the table is movable in two dimensions or three dimensions.

### BRIEF DESCRIPTION OF THE DRAWINGS

FIG. 1 shows a plan view of a die bonding apparatus of a prior art.

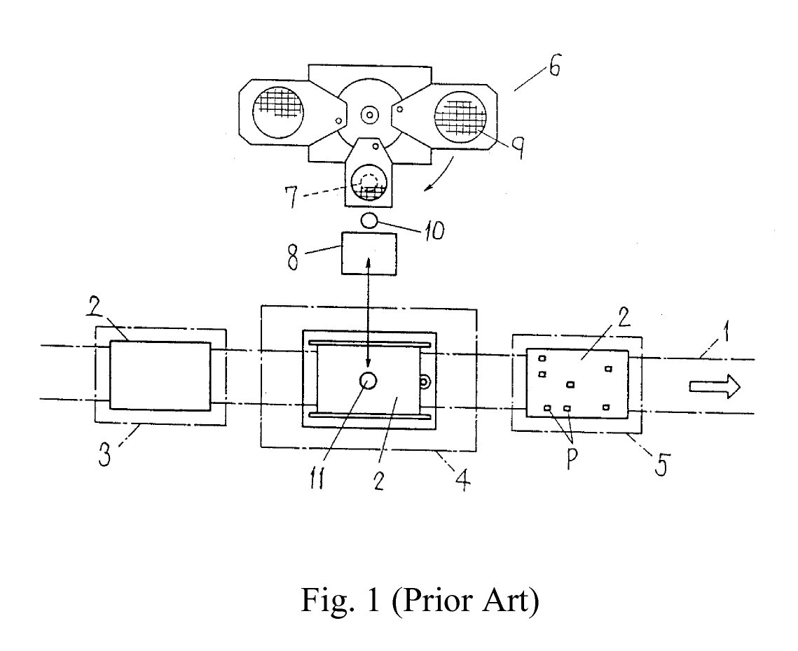

FIG. 2 shows a side view of the substrate transportation path of the prior art.

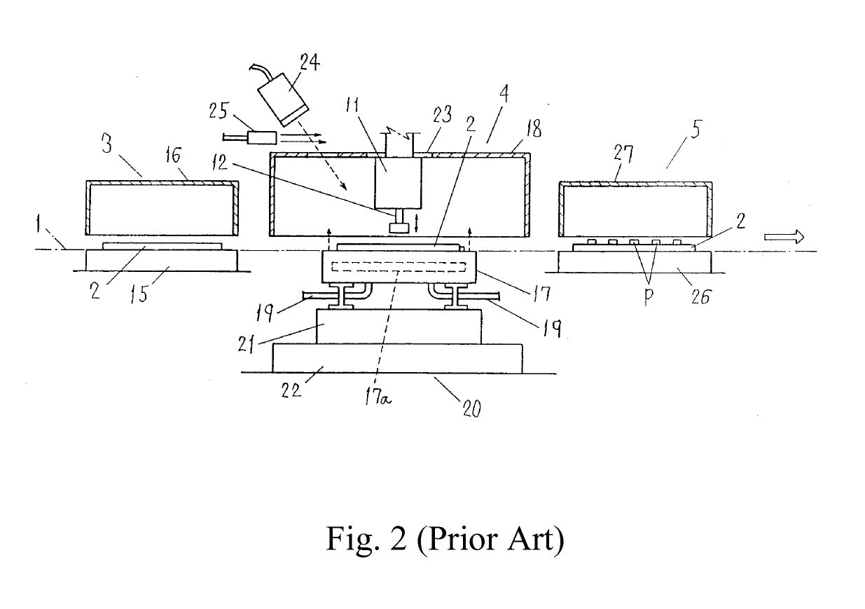

FIG. 3 shows the bonding process of the prior art.

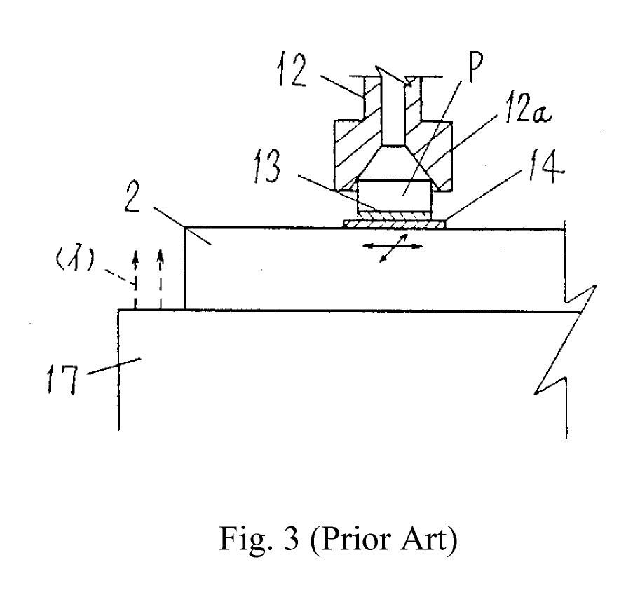

FIG. 4 illustrates a first embodiment of the present invention.

FIG. 5 illustrates a second embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illumination and description only; it is not intended to be exhaustive or to be limited to the precise form disclosed.

In order to have good understanding of the spirit of the present invention, two embodiments are provided below with detailed description.

### First Embodiment

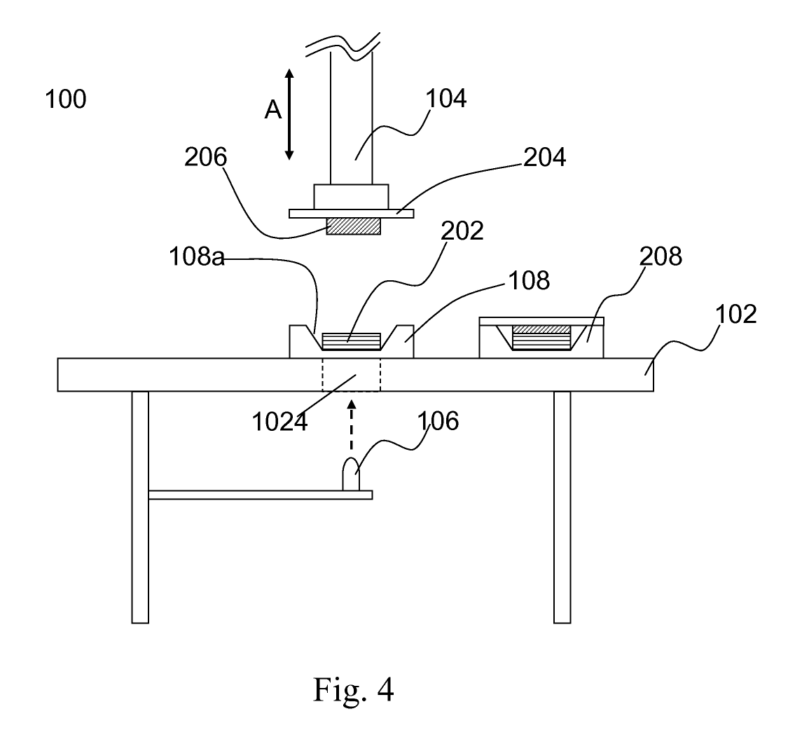

Please refer to FIG. 4. A first embodiment is illustrated. A laser heating apparatus 100 for metal eutectic bonding has a table 102, a mechanical arm 104 and a laser generator 106. The table 102 supports substrates 108 having a first metal 202 to be bonded with a second metal 206. Each substrate 108 has a recess 108a for accommodating the first metal 202. The mechanical arm 104 acts as a holding unit and is located above the table 102. It moves with respect to the table 102 and is used for picking-up, holding and positioning an object 204, which has the second metal 206, above the table 102. In this embodiment, the mechanical arm 104 is movable in two dimensions, i.e., up and down as indicated by arrow A in FIG. 4, and backward and forward (for picking up the object 204) perpendicular to the paperface of FIG. 4.

The laser generator 106 is installed below the table 102 and moves with respect to the table 102. It can provide a laser beam which passes through the table 102 and the substrate 108 to melt the first metal 202. It can also facilitate the first metal 202 to adhere to the second metal 206. The laser beam generated from the laser generator 106 is not limited to any specified wavelength as long as the laser beam is efficient for heating purpose. The table 102 may have a hole 1024 (shown in virtual lines) for the laser beam to pass through the table 102 if the table is not transparent to the laser beam. Generally, bonding of the substrate 108 and the object 204 is completed and a combination 208 is formed after the generator 106 heats the first metal 202 and the second metal 206 contacts with the first metal 202.

In this embodiment, in order to speed up bonding rate for mass production, the table 102 can move horizontally to position the first metal 202 with the generator 106. The movement is two dimensional.

The mechanical arm 104 can heat the second metal 206 before the second metal 206 contacts the first metal 202 so that it is earlier to meet the eutectic bonding temperature. By this way, bonding time can be saved. However, if the eutectic bonding temperature is not high, time for bonding is not critical or the second metal 206 is very thin, the mechanical arm 104 can heat the second metal 206 when the second metal 206 contacts the first metal 202.

If needed, the mechanical arm 104 can exert a pressure onto the second metal 206 when the second metal 206 contacts the first metal 202. It increases bonding intensity such that bonding quality can be improved. Traditionally, bonding process of two metals takes approximately 10 seconds making the manufacturing process takes approximately 30 seconds. However, only less than 1 second is needed for bonding in the present invention. In addition, the mechanical arm 104 can position the second metal 206 to contact the first metal 202.

In the present invention, the first metal 202 is a single element or an alloy. The second metal 206 is also a single element or an alloy. In this embodiment, in order to bond the substrate 108 and the object 204 and have good electrical and thermal conductivity, the first metal 202 is alloy of gold and cooper (Au/Cu) and the second metal is gold (Au). The substrate 108 is made of a material which is transparent to the laser beam, such as silicon, plastic, glass, ceramic, zinc selenide (ZnSe), calcium fluoride (CaF₂) or any other materials through which the laser beam can penetrate.

Furthermore, a carrier (not shown) can be provided under the substrates 108 for shifting the substrates 108 along the table 102 while the mechanical arm 104 and the laser generator 106 are in fixed position.

Although a number of substrates 108 are separately placed on the table 102 for individually bonding to the object 204 in this embodiment, a single wafer having a number of first metals formed thereon can be used to replace the aforementioned substrates 108.

### Second Embodiment

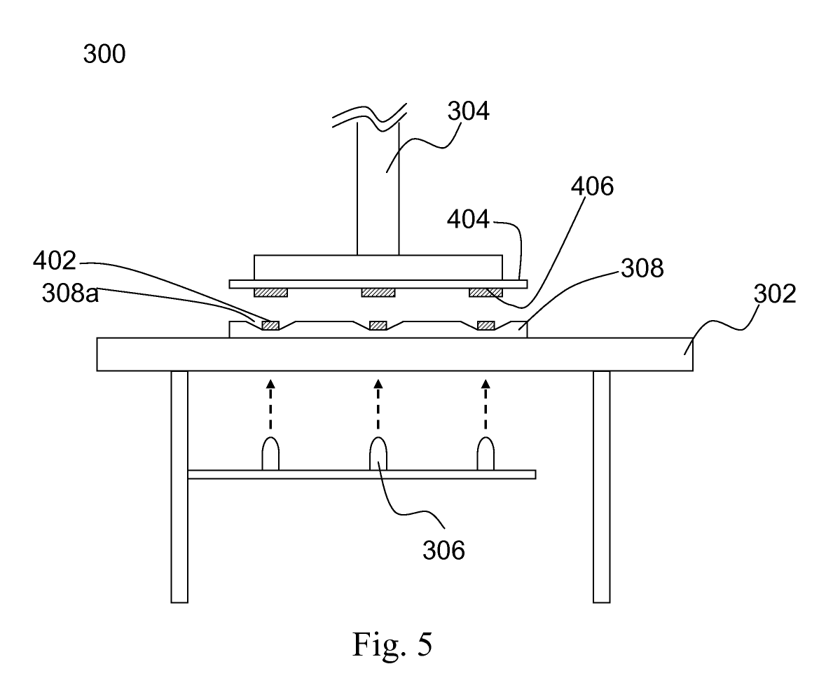

Please refer to FIG. 5. A second embodiment is illustrated. It shows an application of the present invention to wafer bonding. More specifically, two wafers are bonded by eutectic bonding process. A laser heating apparatus 300 for metal eutectic bonding has a table 302, a mechanical arm 304 and a number of laser generators 306. The table 302 supports a first wafer 308 having a number of first metals 402 formed thereon. It can be deemed as a special case of the substrate mentioned in the first embodiment. The first metals 402 will be bonded with corresponding second metals 406 on the other wafer. The first wafer 308 has a number of recesses 308a as that of first metals 402 for accommodating the first metals 402. The mechanical arm 304 is located above the table 302. It moves with respect to the table 302 and is used for picking-up, holding and positioning a second wafer 404 which has the second metals 406 above the table 302. The second metals 406 formed on the second wafer 404 are used for eutectic bonding. In this embodiment, the mechanical arm 304 can move in three dimensions to complete its functions.

The laser generators 306 are installed below the table 302 and can move with respect to the table 402. Alternatively, the laser generators 306 can move with respect to the position of the first metals 402 on the first wafer 308. The laser generators 306 can provide laser beams which passes through the table 302 and the first wafer 308 to melt the first metals 402. They can also facilitate the first metals 402 to adhere to the second metals 406. It should be noticed that a single laser generator 306 is workable, too. The single laser generator 306 can heat all the first metals 402 one by one.

The table 302 is made of glass so that the laser beam can pass through the table 302. In practice, it can be made of silicon, plastic, ceramic, zinc selenide (ZnSe), calcium fluoride (CaF₂) or any other materials through which the laser beam can penetrate. Generally, bonding of the first wafer 308 and the second wafer 404 is completed and two wafers 308 and 404 are bonded together after the generators 306 heat the first metals 402 and the second metals 406 are contacted with the first metals 402.

In this embodiment, the table 302 can move in two dimensions. It means that the table 302 can adjust the first wafer 308 so that each laser generator 306 aims at the corresponding first metal 402.

The mechanical arm 304 can heat the second metals 406 before the second metals 406 contact the first metals 402 so that it is earlier to meet the eutectic bonding temperature. By this way, bonding time can be saved. As in the first embodiment, if the eutectic bonding temperature is not high, time for bonding is not critical or the second metals 406 are very thin, the mechanical arm 304 can heat the second metals 406 when the second metals 406 contact the first metals 402. If needed, the mechanical arm 304 can exert a pressure onto the second metals 406 when the second metals 406 contacts the first metal 402. It helps improve bonding quality and saves bonding time.

In the present invention, the first metal 402 is made of gold (Au). The second metal 406 is also made of gold (Au). The first wafer 308 is made of silicon which is transparent to the laser beam. It ensures the laser beams can pass through the first wafer 308 to heat first metals 402 without damage of the first wafer 308 itself.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A laser heating apparatus for metal eutectic bonding, comprising:
a table, for supporting a substrate having a first metal;
a holding unit, located above the table and moving with respect to the table, for holding an object having a second metal above the table; and
a laser generator, installed below the table and moving with respect to the table, for providing a laser beam which passes through the table and the substrate to melt the first metal, to facilitate the first metal to adhered to the second metal, thereby bonding the substrate with the object.

2. The laser heating apparatus according to claim 1, wherein the holding unit heats the second metal before or when the second metal contacts the first metal.

3. The laser heating apparatus according to claim 1, wherein the holding unit does not heat the second metal either before or when the second metal contacts the first metal.

4. The laser heating apparatus according to claim 1, wherein the holding unit exerts a pressure onto the second metal when the second metal contacts the first metal.

5. The laser heating apparatus according to claim 1, wherein the holding unit does not exert a pressure onto the second metal when the second metal contacts the first metal.

6. The laser heating apparatus according to claim 1, wherein the substrate comprises a recess for accommodating the first metal.

7. The laser heating apparatus according to claim 1, wherein the holding unit is a mechanical arm.

8. The laser heating apparatus according to claim 1, wherein the holding unit is movable in two dimensions.

9. The laser heating apparatus according to claim 1, wherein the holding unit is movable in three dimensions.

10. The laser heating apparatus according to claim 1, wherein the holding unit positions the second metal to contact the first metal.

11. The laser heating apparatus according to claim 1, wherein the first metal is a single element or is an alloy.

12. The laser heating apparatus according to claim 1, wherein the second metal is a single element or is an alloy.

13. The laser heating apparatus according to claim 1, wherein the table and the substrate are made of materials which are transparent to the laser beam.

14. The laser heating apparatus according to claim 13, wherein the table is made of silicon, plastic, glass, ceramic, zinc selenide (ZnSe), calcium fluoride (CaF₂) or any other materials through which the laser beam can penetrate.

15. The laser heating apparatus according to claim 13, wherein the substrate is made of silicon, plastic, glass, ceramic, zinc selenide (ZnSe), calcium fluoride (CaF₂) or any other materials through which the laser beam can penetrate.

16. The laser heating apparatus according to claim 1, wherein the table is movable in two dimensions.

17. The laser heating apparatus according to claim 1, wherein the table is movable in three dimensions.
